(19) United States
(12) Patent Application Publication
(10) Pub. No.: US 2004/0129802 A1
(43) Pub. Date: Jul. 8, 2004

(54) Hopper spray gun stand

(76) Inventor: Timmy R. Bell SR., Shreveport, LA (US)

Correspondence Address: Mark J. Young, Suite 227, 9951 Atlantic Blvd., Jacksonville, FL, 32225, US

(21) Appl. No.: 10/741,072

(22) Filed: Dec. 19, 2003

Related U.S. Application Data
(60) Provisional application No. 60/434,836, filed on Dec. 19, 2002.

(51) Int. Cl. A01G 25/14

(52) U.S. Cl. 239/379; 239/376

(57) ABSTRACT

A hopper spray gun stand holds a hopper spray gun upright, such as during filling and between uses, and facilitates transportation of a hopper spray gun around a job site. The stand includes a frame with a hopper holder, legs and wheels facilitate transportation.

### RELATED APPLICATIONS

This application claims priority to U.S. Provisional Application 60/434,836, filed Dec. 19, 2003, the entire contents of which are hereby incorporated by reference herein.

### FIELD OF THE INVENTION

The present invention pertains to hopper spray guns. More particularly, the present invention pertains to a device and method for securely holding a hopper spray gun in an upright position and facilitating transportation of the hopper spray gun and related equipment such as hoses to and from a job site.

### BACKGROUND

Hopper spray guns are used to apply a coating of material to walls and/or ceilings. The material may be joint compound or the like, which is commonly referred to in the field as “mud”; or it may be a light-weight material designed to acoustically treat a surface to make a quieter room, which is commonly referred to in the field as “acoustics”.

Conventional hopper spray guns do not have means to support them upright on the ground while being filled or between uses. Thus, a worker will often sandwich the hopper spray gun between the worker's legs or lean it against a wall while filling it. Of course, these techniques are awkward and conducive to spilling and tipping.

Likewise, between uses, workers will frequently rest a semi-filled hopper spray gun against a wall or other object while the worker takes a needed break or attends to other matters. Frequently, such a precariously positioned hopper spray gun will tip over. As most hopper spray guns have openings at the top, such tipping may result in a mess with contents spilled on the floor and wasted. Not only does such a mess consume time to clean up and increase material costs, it poses a potential safety hazard.

Another deficiency is the lack of means for conveniently transporting a hopper spray gun and related equipment such as hoses. A worker may make several trips from the job site to a truck for carrying equipment. Conventional hopper spray guns are neither lightweight nor compact, making the task burdensome.

Thus, a device and method are needed for securely holding a hopper spray gun upright during filling and between uses. Preferably, the device also facilitates transportation of the equipment to and around a job site.

### SUMMARY

It is, therefore, an object of a preferred embodiment of the present invention to provide a device for securely holding a hopper spray gun upright.

It is another object of a preferred embodiment of the present invention to provide a device for facilitating transportation of hopper spray gun equipment to and around a job site.

It is yet another object of a preferred embodiment of the present invention to provide a device for securely holding a hopper spray gun upright using a holding means that accommodates various conventional hopper spray guns.

It is a further object of a preferred embodiment of the invention to provide a device for facilitating transportation of hopper spray gun equipment to and around a job site and carrying hoses and/or other equipment and materials.

It is still a further object of a preferred embodiment of the invention to provide a device for securely holding and weighing a hopper spray gun.

To achieve these and other objects, the present invention provides a hopper spray gun stand comprised of a frame, a hopper holder attached to the frame, a pair of legs attached to the frame, and a plurality of wheels. The wheels are rotatably attached to the frame.

Additionally, the invention provides a collapsible hopper spray gun stand comprised of a frame, a hopper holder attached to the frame, a pair of legs attached to the frame, and a plurality of wheels, said wheels being rotatably attached to the frame.

### BRIEF DESCRIPTION OF THE DRAWINGS

The foregoing and other objects, features and advantages of the present invention will become better understood with reference to the following description, appended claim, and accompanying figures, where:

FIG. 1 is a perspective view of a conventional hopper spray gun;

FIG. 2 is a perspective view of an exemplary device for holding a hopper spray gun in accordance with a preferred implementation of the present invention;

FIG. 3 is a side view of an exemplary device for holding a hopper spray gun in accordance with a preferred implementation of the present invention; and

FIG. 4 is a rear view of an exemplary device for holding a hopper spray gun in accordance with a preferred implementation of the present invention; and

FIG. 5 is a side view of a folded exemplary device for holding a hopper spray gun in accordance with a preferred implementation of the present invention.

### DETAILED DESCRIPTION

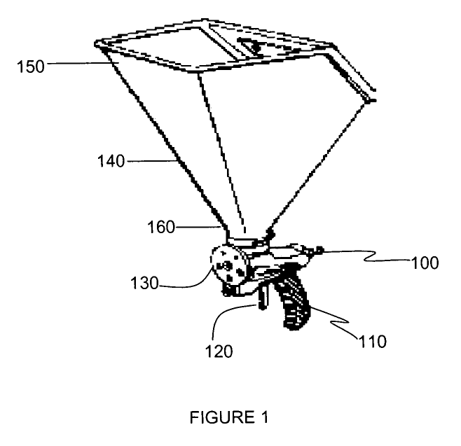

Referring first to FIG. 1, an exemplary hopper spray gun is illustrated. It includes a spray mechanism 100 with a handle 110, trigger 120 and nozzle 130. A hopper 140 is also provided to contain material to be sprayed and direct the material in a funnel-like fashion to the spray mechanism 100. As can readily be seen, the cross section of the hopper tapers substantially from the broad top section 150 to the relatively narrow outlet section 160 which engages the spray mechanism.

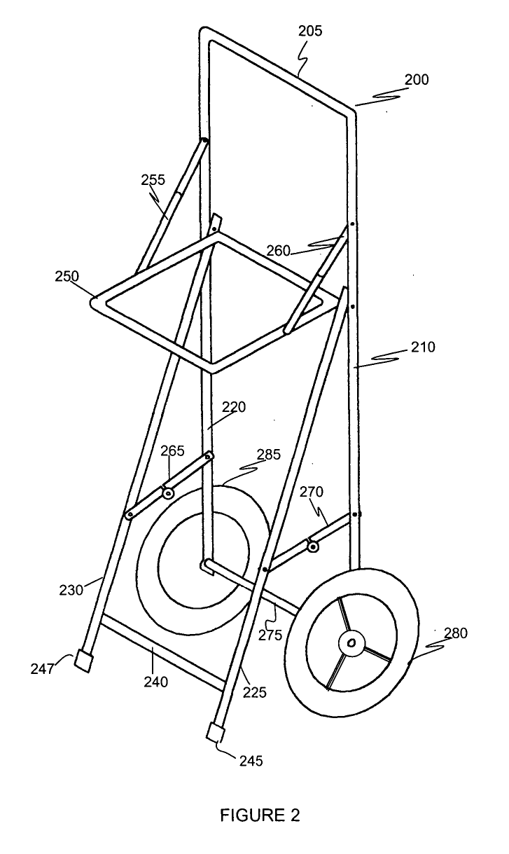

Referring now to FIG. 2, an exemplary hopper spray gun stand according to the principles of the invention is shown. The exemplary hopper spray gun stand generally includes a frame 200, a hopper holder 250 attached to the frame 200, a pair of legs 225 and 230 attached to the frame, and wheels 280 and 285 to facilitate movement.

The frame 200 provides a base to which the hopper holder 250, pair of legs 225 and 230, and wheels 280 and 285 may be attached. In an exemplary implementation, the frame 200 is a U-shaped member having a handle portion 205 a first lateral portion 210 and a second lateral portion 220. The handle portion 205 may include handle grips to facilitate gripping. Those skilled in the art will appreciate that other shaped frames (e.g., I-shaped, H-shaped or T-shaped frames) may be used without departing from the scope of the present invention.

The frame 200 may be comprised of a single piece of material, or several pieces attached together such as by welding, soldering or mechanical attachment (e.g., using nuts and bolts). The material, which may (for example) be metal, wood or plastic, is preferably relatively inexpensive, strong and durable enough to consistently support a fully loaded hopper spray gun along with related components and miscellaneous items. The material may also be corrosion resistant or treated (e.g., painted) to resist corrosion. In an exemplary embodiment, the frame is comprised of bent tubular steel.

The hopper holder 250 holds a hopper spray gun in an upright position. The exemplary hopper holder 250 shown in FIG. 2 is a continuous rectangular rim. A hopper spray gun may rests in the rectangular opening defined by the rim. The dimensions (i.e., length and/or width) of the opening are smaller than the dimensions of the top widest portion of a hopper for a hopper spray gun. Thus, the rectangular horizontal cross section of a hopper spray gun prevents the hopper spray gun from falling through the smaller opening of the hopper holder. The dimensions at or near the top of a hopper vary slightly from brand to brand and model to model. However, the top of many conventional hoppers is between ten (10) to eleven (11) inches by nine (9) to ten (10) inches. Additionally, most conventional hoppers have a lip or protruding edge at the top. Preferably, the hopper holder 250 is sized to securely engage various conventional hopper spray guns. It should be large enough to engage the hopper near its top, but not so large that the hopper falls through the hopper holder. Thus, a hopper holder 250 sized approximately ten (10) inches by nine (9) inches will support many hopper spray guns.

The hopper holder 250 may be comprised of a single piece of material or several pieces attached together to form a continuous rim. Alternatively, the rim may have a gap, and may be comprised of a plurality of pieces, for example, as shown in FIG. 4. Where multiple pieces are used to form the rim, they may be joined using conventional joining techniques such as by welding, soldering or mechanical attachment (e.g., using nuts and bolts). The material, which may (for example) be metal, wood or plastic, is preferably relatively inexpensive, strong enough to support a fully loaded hopper spray gun, and durable. The material may also be corrosion resistant or treated (e.g., painted) to resist corrosion. In an exemplary embodiment, the hopper holder 250 is comprised of bent tubular steel.

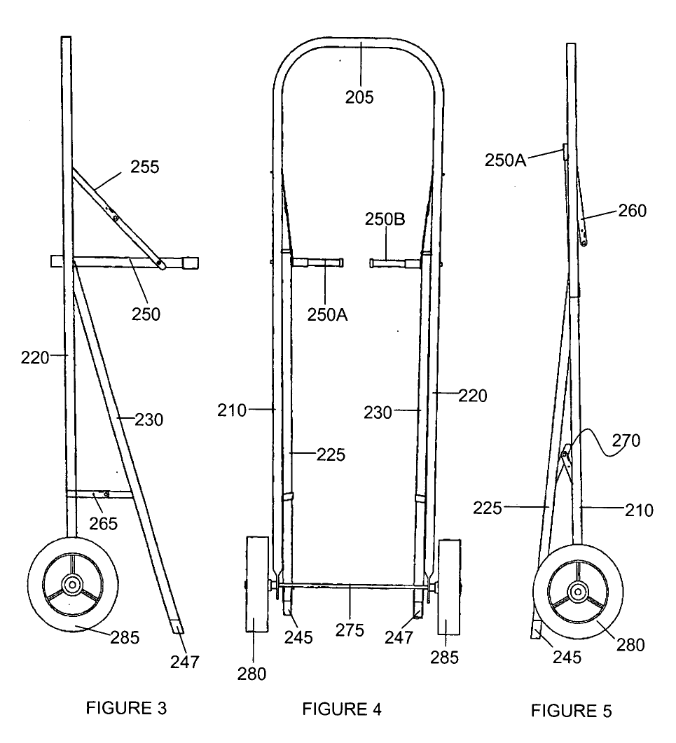

In a preferred embodiment, the hopper holder 250 is pivotally attached to the frame, so that it may be folded for storage. A foldable first hopper linkage 255, and a foldable second hopper linkage 260 support the hopper holder 250 in a position generally perpendicular to the frame, as shown in FIGS. 2 and 3. Foldable first hopper linkage 255 and a foldable second hopper linkage 260 may be folded to allow the hopper holder 250 to be folded for storage, such that it is generally parallel to the frame.

In another embodiment, the hopper holder 250 may be adjustable to accommodate hopper spray guns having various sizes. For example, hopper holder 250 may include telescoping tubular or threaded members that are adjustable and lockable to accommodate hoppers of various sizes.

In yet another embodiment, a scale may be functionally attached to the hopper holder 250 and/or to the first hopper linkage 255 and/or second hopper linkage 260 to measure the weight of the contents of (e.g., mud or acoustics) a hopper spray gun held by the hopper holder 250. The scale may be comprised of a mechanical scale device or one or more electromechanical sensors coupled to a processor and output display, as known in the art. The scale may include a tare or zero function to enable display of the weight of contents, without the weight of the hopper spray gun. Knowing the weight of the contents used to spray a room will enable a worker to estimate the weight of the contents required to spray another room or the weight required for another job.

A pair of legs 225 and 230 supports the stand in an upright position. In a preferred embodiment, the pair of legs 225 and 230 includes a pair of pivotable legs 225 and 230 with a horizontal support member 240. Non-skid caps 245 and 247 may be placed over the bottom ends of the legs 225 and 230 to prevent the legs 225 and 230 from skidding and scratching floors.

Preferably, the legs 225 and 230 are pivotally attached to the frame 200 so that the legs 225 and 230 may be folded for storage. A foldable first leg linkage 265, and a foldable second leg linkage 270 support the legs 225 and 230 in an extended position. Of course, foldable first and second hopper linkages 255 and 260 may be folded to allow the legs 225 and 230 to be folded for storage, such that they are generally parallel to the frame.

The legs 225 and 230 and horizontal leg support 240 may be comprised of a single piece of material, or several pieces attached together such as by welding, soldering or mechanical attachment (e.g., using nuts and bolts). The material, which may (for example) be metal, wood or plastic, is preferably relatively inexpensive, strong enough to support a fully loaded hopper spray gun, attached components and miscellaneous items, and should be durable. The material may also be corrosion resistant or treated (e.g., painted) to resist corrosion. In an exemplary embodiment, the legs 225 and 230 and horizontal leg support 240 are each comprised of tubular steel joined together by welding, soldering or mechanical attachments.

In an exemplary embodiment, wheels 280 and 285 are rotatably attached to the frame 200 in a conventional manner, such as via an axle 275. Those skilled in the art will appreciate that the present invention may function as a stand without wheels. While such a stand is not preferred, it comes within the scope of the present invention. Those skilled in the art will also appreciate that configurations having more than one pair of wheels also come within the scope of the present invention. However, a stand with a single pair wheels is preferred to facilitate transportation without unnecessary additional cost or complexity.

The axle 275 may be a conventional steel axle rod that is long enough to engage the first lateral portion 210 and second lateral portion 220 of the frame 200 adjacent to the bottom of the lateral portions. The wheels 280 and 285 may be attached to the axle 275 using conventional wheel-to-axle attachments. The wheels 280 and 285 may be comprised of metal, plastic and/or rubber. Preferably, the wheels will not damage floors. They should be strong enough to support the weight of the stand with a fully loaded hopper spray gun and miscellaneous equipment (e.g., hoses and tools).

A stand in accordance with an exemplary embodiment of the present invention may further include means for carrying additional equipment and materials, such as hooks, loops, baskets, nets, pouches, trays, bins, cups, cup holders, clamps, brackets, shelves and the like. Such additional equipment may include hoses, cords, and/or containers of materials for spraying. As an example, hooks, loops, baskets, pouches, shelves and the like may be attached at various places on the frame 200 or the legs 225, 230. As another example, a foldable shelf may be placed between the pair of legs 225 and 230 and the frame 200.

Referring now to FIG. 3, a side view of an exemplary hopper spray gun stand according to the principles of the invention is shown. The second lateral portion 220, foldable first leg linkage 265, leg 230, hopper holder 250, first hopper linkage 255 and non-skid cap 247, and wheel 285 are shown. The hopper spray gun stand of FIG. 3 is shown in an open position.

Referring now to FIG. 4, a rear view of an alternative exemplary hopper spray gun stand according to the principles of the invention is shown. Unlike the stand depicted in FIG. 2, the hopper holder 250A and 250B of the stand depicted in FIG. 4 includes a gap as discussed above. Portions 250A and 250B may be telescopic portions or fixed length portions, as discussed above.

Referring now to FIG. 5, another side view of an exemplary hopper spray gun stand according to the principles of the invention is shown. The first lateral portion 210, foldable second leg linkage 270, leg 225, the hopper holder 250A, first hopper linkage 260, non-skid cap 245, and wheel 280 are shown. The hopper spray gun stand of FIG. 5 is shown in a closed or collapsed position.

While the invention has been described in terms of its preferred embodiments, those skilled in the art will recognize that the invention can be practiced with modifications within the spirit and scope of the foregoing detailed description. Such alternative embodiments and implementations are intended to come within the scope of the present invention.

Having thus described the invention, what is claimed and desired to be secured by Letters Patent is as follows:

1. A hopper spray gun stand comprised of a frame, a hopper holder attached to the frame, a pair of legs attached to the frame, and a plurality of wheels, said wheels being rotatably attached to the frame.

2. A hopper spray gun stand according to claim 1, wherein the hopper holder is pivotally attached to the frame.

3. A hopper spray gun stand according to claim 1, wherein the pair of legs are pivotally mounted to the frame.

4. A hopper spray gun stand according to claim 1, wherein the hopper holder is comprised of a rim.

5. A hopper spray gun stand according to claim 4, wherein the rim is a continuous rim.

6. A hopper spray gun stand according to claim 4, wherein the rim is a discontinuous rim.

7. A hopper spray gun stand according to claim 2, further comprising at least one foldable linkage connected to the hopper holder and the frame.

8. A hopper spray gun stand according to claim 3, further comprising at least one foldable linkage connected to each leg and the frame.

9. A hopper spray gun stand according to claim 1, further comprising a non skid cap attached to each leg.

10. A hopper spray gun stand according to claim 1, further comprising a storage device attached to the frame, the storage device being comprised of a structure from the group consisting of a hook, a loop, a basket, a net, a pouch, a tray, a bin, a cup, a cup holder, a clamp, a bracket, a shelf.

11. A hopper spray gun stand according to claim 1, wherein the wheels are comprised of a plastic or rubber material.

12. A collapsible hopper spray gun stand comprised of a frame, a hopper holder attached to the frame, a pair of legs attached to the frame, and a plurality of wheels, said wheels being rotatably attached to the frame.

13. A hopper spray gun stand according to claim 12, wherein the hopper holder is pivotally attached to the frame.

14. A hopper spray gun stand according to claim 13, wherein the pair of legs are pivotally mounted to the frame.

15. A hopper spray gun stand according to claim 14, wherein the hopper holder is comprised of a rim.

16. A hopper spray gun stand according to claim 15, wherein the rim is a continuous rim.

17. A hopper spray gun stand according to claim 15, wherein the rim is a discontinuous rim.

18. A hopper spray gun stand according to claim 14, further comprising at least one foldable linkage connected to the hopper holder and the frame.

19. A hopper spray gun stand according to claim 18, further comprising at least one foldable linkage connected to each leg and the frame.

20. A hopper spray gun stand according to claim 19, further comprising a non skid cap attached to each leg.
